(19) United States
(12) Patent Application Publication
(10) Pub. No.: US 2016/0008212 A1
(43) Pub. Date: Jan. 14, 2016

(54) Rotating and Extensible Swinging Massage Head Unit

(71) Applicant: ST LIFE CO., LTD., Taichung City (TW)

(72) Inventor: Jue-Yao Chen, Taichung City (TW)

(21) Appl. No.: 14/327,614

(22) Filed: Jul. 10, 2014

(51) Int. Cl. A61H 15/00

(52) U.S. Cl. CPC A61H 15/0078; A61H 2201/1215

(57) ABSTRACT

A rotating and extensible swinging massage head unit includes: a ring having an eccentric shaft hole; a swinging arm extending laterally from the ring, the swinging arm having a centrally-located oblong limiting slot, a driven side connected to the ring, and an active side having thereon a massage bump, an eccentric shaft inserted into the eccentric shaft hole of the ring and having therein a central axial pore; a turntable disposed integrally on a top side of the eccentric shaft and being concentric with the central axial pore, wherein a massage hemisphere is disposed protrudingly on a top side of the turntable. Rotation of the eccentric shaft swings the swinging arm to perform a swinging kneading massage and rotates the turntable to perform a rotating massage simultaneously.

### BACKGROUND OF THE INVENTION

1. Technical Field

The present invention relates to the technical field of massage head units, and more particularly, to a rotating and extensible swinging massage head unit which comprises a swinging arm with a driven side capable of swinging eccentrically, a centrally-located oblong limiting slot, and an active side having thereon a massage bump, wherein a turntable is disposed on the top side of the eccentric shaft and being concentric with the eccentric shaft, and a massage hemisphere is disposed on the top side of the turntable. Rotation of the eccentric shaft swings the swinging arm to perform a swinging kneading massage and rotates the turntable to perform a rotating massage and simultaneously.

2. Description of Related Art

People nowadays work much but spend little time on leisure activities. Being tense all the time, people nowadays crave a break from one's toils. In view of this, it is necessary for people nowadays to go for a massage. A massage does not take up much space, nor does it require participants to move around; hence, persons at rest can have a massage to exercise and relax the body, thereby getting good rest. When carried out properly, muscle exercise enhances blood circulation, boosts metabolism, keeps the body healthy, and reduces stress.

Conventional massagers perform a massage monotonously. For example, Taiwan patent application 100216719 is entitled Massager Structure, regarded as one of the commonest types of massagers, that is, disc massagers, and adapted to perform a rotating massage. Although the disc massagers can also move vertically and laterally, the disc massagers are intended mostly for the rotating massage and in consequence are impossible to exercise and relax every muscle of the body. As a result, there is still room for improvement of conventional massagers.

### SUMMARY OF THE INVENTION

It is an objective of the present invention to provide a rotating and extensible swinging massage head unit which comprises a swinging arm. The swinging arm has a driven side capable of swinging eccentrically, a centrally-located oblong limiting slot, and an active side having thereon a massage bump. A turntable is disposed integrally on a top side of the eccentric shaft and is concentric with the eccentric shaft, wherein a massage hemisphere is disposed protrudingly on a top side of the turntable. Rotation of the eccentric shaft swings the swinging arm to perform a swinging kneading massage and rotates the turntable to perform a rotating massage simultaneously.

In order to achieve the above and other objectives, the present invention provides a rotating and extensible swinging massage head units, comprising: a ring having an eccentric shaft hole; a swinging arm integrally extending laterally from the ring, with the swinging arm having a centrally-located oblong limiting slot, a driven side connected to the ring, and an active side having thereon a massage bump; an eccentric shaft inserted into the eccentric shaft hole of the ring and having therein a central axial pore; and a turntable disposed integrally on a top side of the eccentric shaft and being concentric with the central axial pore, wherein a massage hemisphere is disposed protrudingly on a top side of the turntable. Rotation of the eccentric shaft swings the swinging arm to perform a swinging kneading massage and rotates the turntable to perform a rotating massage simultaneously.

### BRIEF DESCRIPTION OF THE DRAWINGS

FIG. 1 is a top exploded view of a rotating and extensible swinging massage head unit according to an embodiment of the present invention;

FIG. 2 is a bottom exploded view of the rotating and extensible swinging massage head unit according to an embodiment of the present invention;

FIG. 3 is an assembled bottom perspective view of the rotating and extensible swinging massage head unit according to an embodiment of the present invention;

FIG. 4 is a schematic view of a swinging arm swinging upward according to the present invention;

FIG. 5 is a schematic view of the swinging arm swinging leftward according to the present invention;

FIG. 6 is a schematic view of the swinging arm swinging downward according to the present invention;

FIG. 7 is a schematic view of the swinging arm swinging rightward according to the present invention;

FIG. 8 is a bottom exploded view of a massager according to the present invention;

FIG. 9 is a schematic top view of the massager according to the present invention;

FIG. 10 is a schematic perspective view of the massager according to the present invention;

FIG. 11 is a schematic perspective view of the massager applied in a massage pillow according to the present invention;

FIG. 12 is a schematic perspective view of the massager applied in a massage chair cushion according to the present invention; and

FIG. 13 is a schematic perspective view of the massager applied in a massage chair according to the present invention.

### DETAILED DESCRIPTION OF THE EMBODIMENT OF THE INVENTION

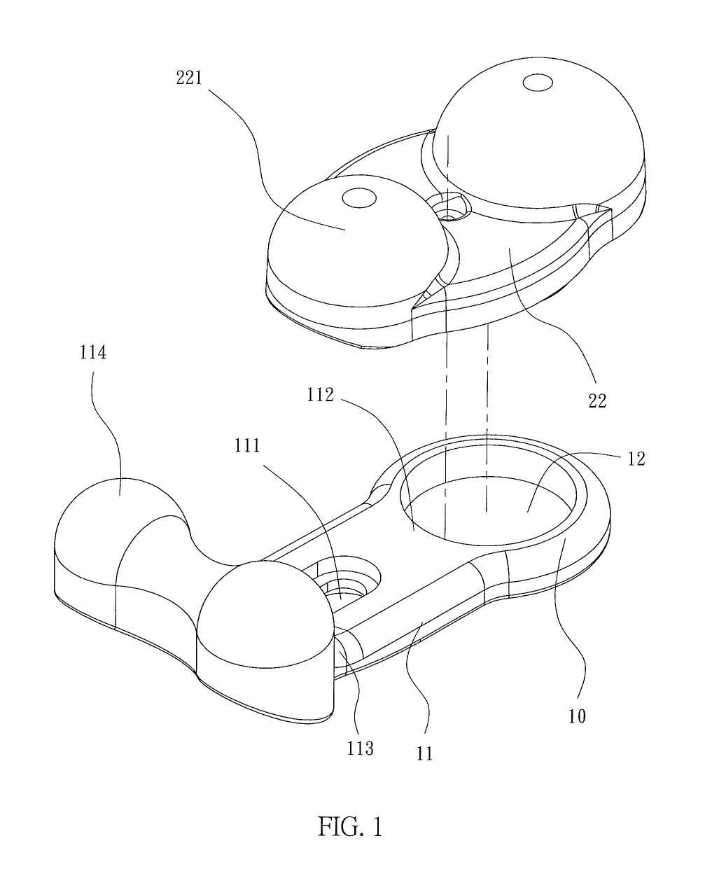

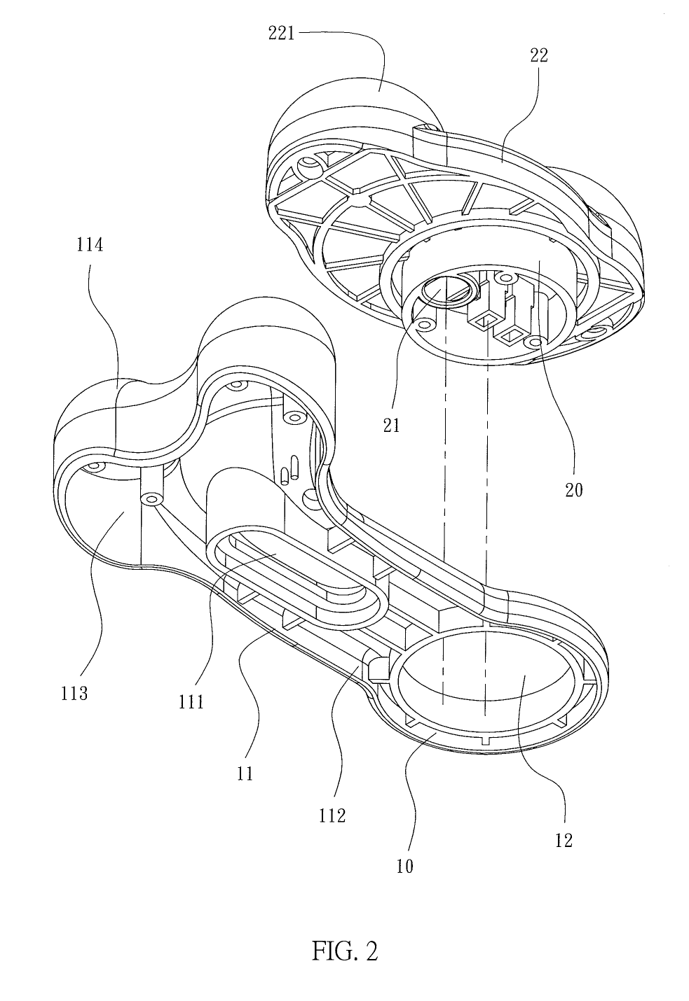

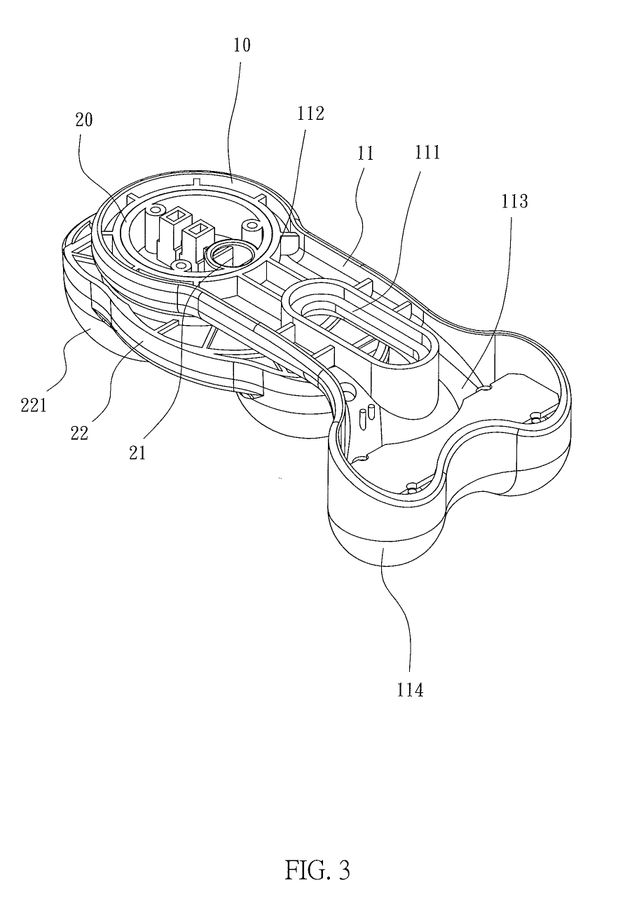

The present invention provides a rotating and extensible swinging massage head unit. Referring to FIG. 1 through FIG. 3, according to the present invention, a rotating and extensible swinging massage head unit comprises a ring 10 having an eccentric shaft hole 12, a swinging arm 11, an eccentric shaft 20, and a turntable 22.

The swinging arm 11 integrally extends laterally from the ring 10. The swinging arm 11 has a centrally-located oblong limiting slot 111, a driven side 112, and an active side 113. The ring 10 is connected to the driven side 112 of the swinging arm 11. At least a massage bump 114 is disposed on the active side 113 of the swinging arm 11. The eccentric shaft 20 is inserted into the eccentric shaft hole 12 of the ring 10. The eccentric shaft 20 has therein a central axial pore 21. The turntable 22 is disposed integrally on the top side of the eccentric shaft 20 and is concentric with the central axial pore 21. At least a massage hemisphere 221 is disposed protruding on the top side of the turntable 22. Hence, rotation of the eccentric shaft swings the swinging arm 11 to perform a swinging kneading massage and rotates the turntable 22 to perform a rotating massage simultaneously.

Referring to FIG. 1, regarding the rotating and extensible swinging massage head unit, the massage hemisphere 221 comprises two massage hemispheres 221.

Referring to FIG. 1, regarding the rotating and extensible swinging massage head unit, the two massage hemispheres 221 comprise a large massage hemisphere 221 and a small massage hemisphere 221.

Referring to FIG. 1 through FIG. 7, regarding the rotating and extensible swinging massage head unit, the eccentric shaft 20 is disposed on the bottom side of the turntable 22, and a central transmission shaft 31 penetrates the top side of a casing 30. The central transmission shaft 31 is inserted into the central axial pore 21 integrally formed with the eccentric shaft 20, such that the central transmission shaft 31 drives the eccentric shaft 20 to rotate. A limiting post 32 is disposed protrudingly on the top side of the casing 30 and engaged with the oblong limiting slot 111 of the swinging arm 11, wherein the range of the swing of the swinging arm 11 is effectively limited by the limiting post 32 and the oblong limiting slot 111.

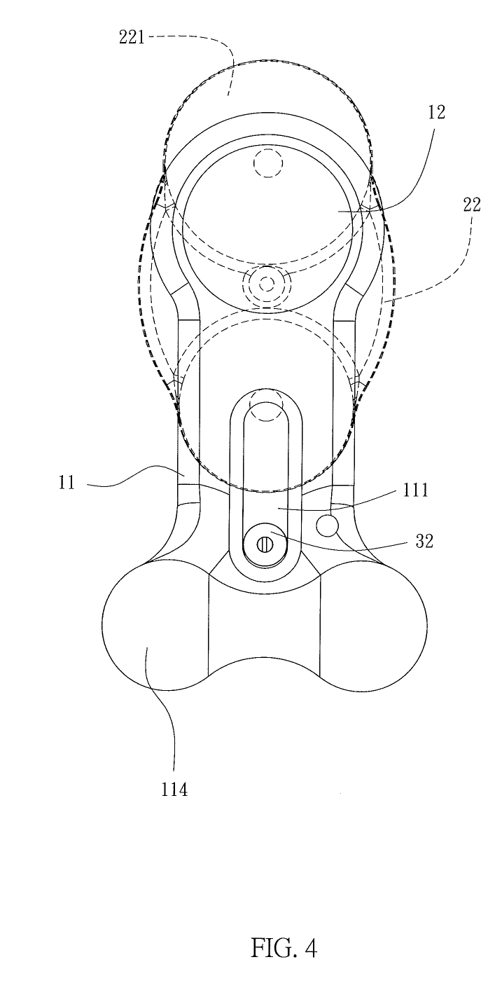

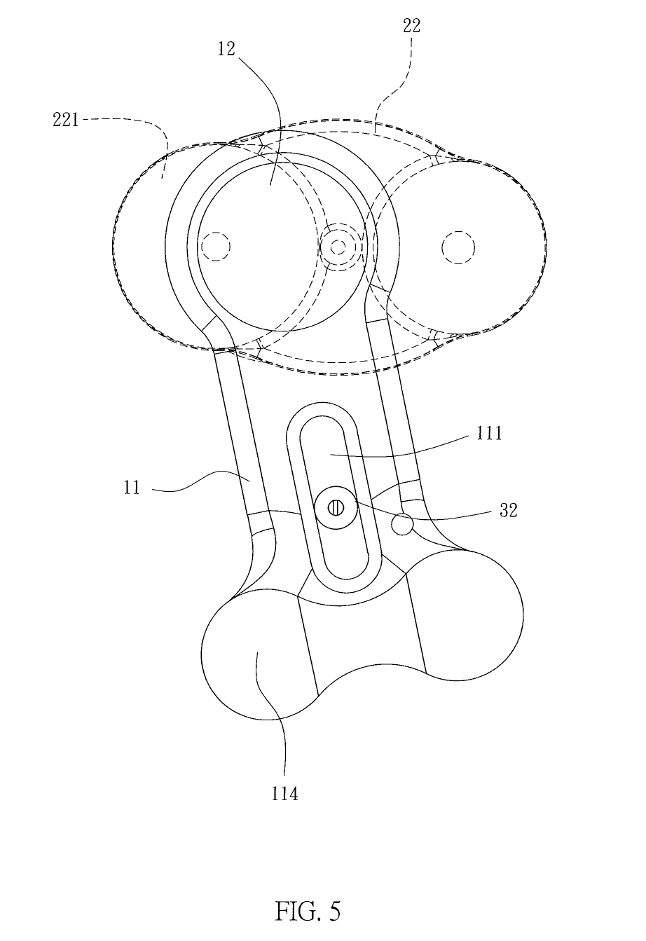

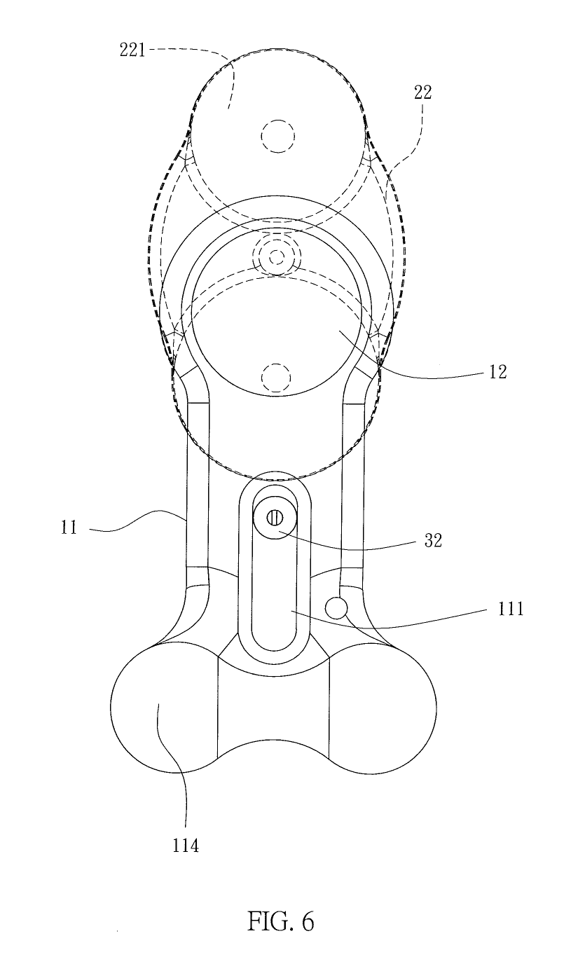

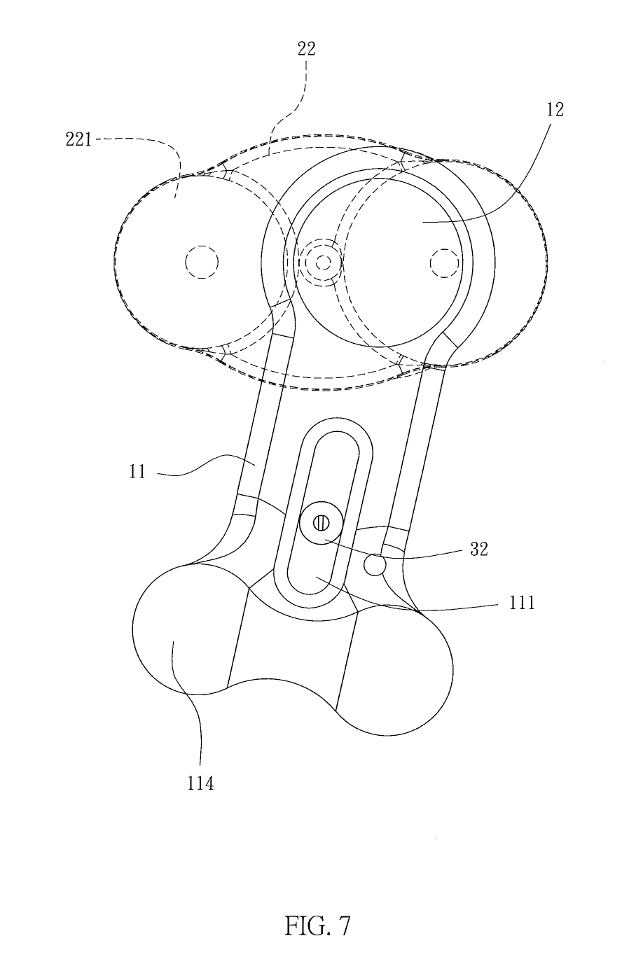

Referring to FIG. 4 through FIG. 7, as the turntable 22 and the eccentric shaft 20 are integrally formed, the central transmission shaft 31 drives the turntable 22 to perform stationary rotation such that the eccentric shaft 20 is capable of rotating and swinging eccentrically. Referring to FIG. 4, the driven side 112 of the swinging arm 11 is driven upward because the eccentric shaft 20 is rotating and swinging upward eccentrically, whereas the active side 113 of the swinging arm 11 slides to the limiting post 32 because of the oblong limiting slot 111 such that the at least a massage bump 114 is driven upward. Referring to FIG. 5, the driven side 112 of the swinging arm 11 is driven leftward because the eccentric shaft 20 is rotating and swinging leftward eccentrically, whereas the active side 113 of the swinging arm 11 slides to the limiting post 32 because of the oblong limiting slot 111 such that the at least a massage bump 114 can only swing rightward. Referring to FIG. 6, the driven side 112 of the swinging arm 11 is driven downward because the eccentric shaft 20 is rotating and swinging downward eccentrically, whereas the active side 113 of the swinging arm 11 slides to the limiting post 32 because of the oblong limiting slot 111 such that the at least a massage bump 114 can only be pushed downward. Referring to FIG. 7, the driven side 112 of the swinging arm 11 is driven rightward because the eccentric shaft 20 is rotating and swinging rightward eccentrically, whereas the active side 113 of the swinging arm 11 slides to the limiting post 32 because of the oblong limiting slot 111 such that the at least a massage bump 114 can only swing leftward.

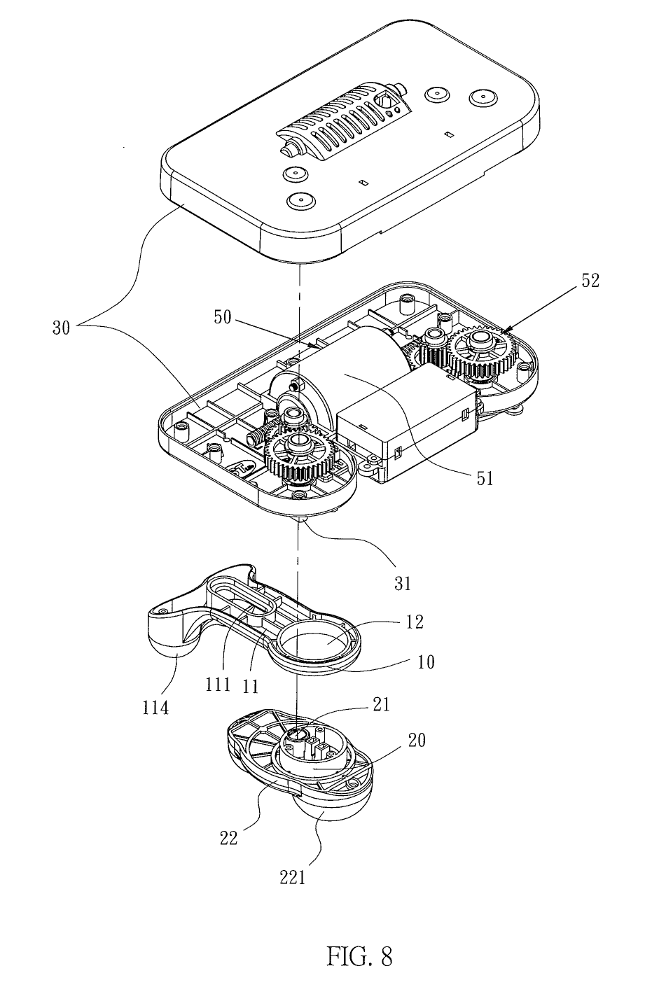

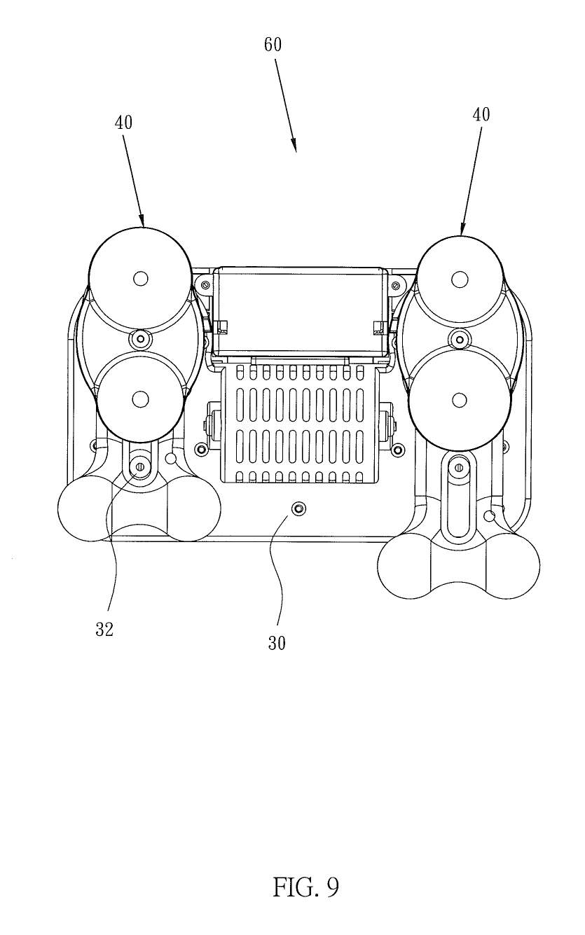

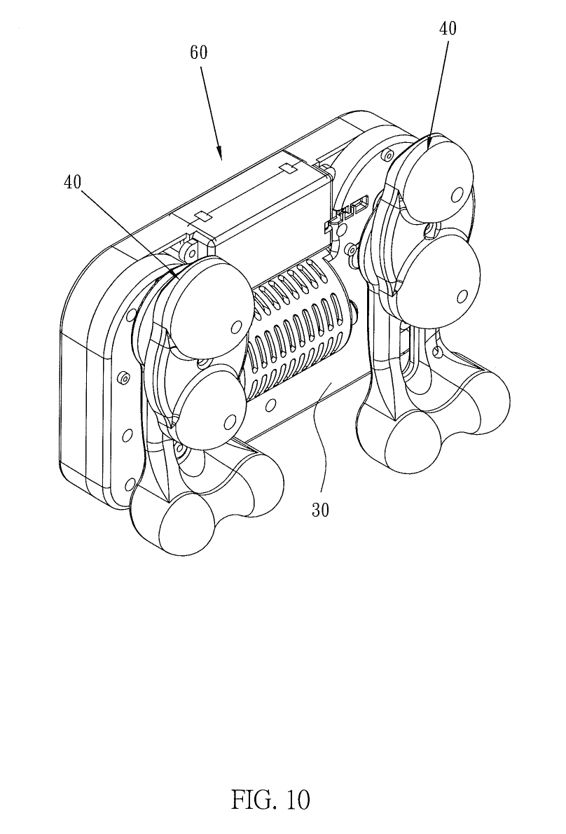

Referring to FIG. 8 through FIG. 10, the rotating and extensible swinging massage head unit comprises two rotating and extensible swinging massage head units 40 arranged side by side in a manner that manifests bilateral symmetry. The casing 30 is connected between the two rotating and extensible swinging massage head units 40. The casing 30 has therein a power mechanism 50. The power mechanism 50 comprises a motor 51 for driving a gear train 52. The gear train 52 drives the central transmission shaft 31 and thus drives the two rotating and extensible swinging massage head units 40; hence, the rotating and extensible swinging massage head units 40 each perform a stationary massage and the swinging arm 11 performs a swinging massage, thereby forming a massager 60. The two rotating and extensible swinging massage head units 40 of the massager 60 perform a stationary massage and a swinging kneading massage on the shoulders, neck, and back of a human body.

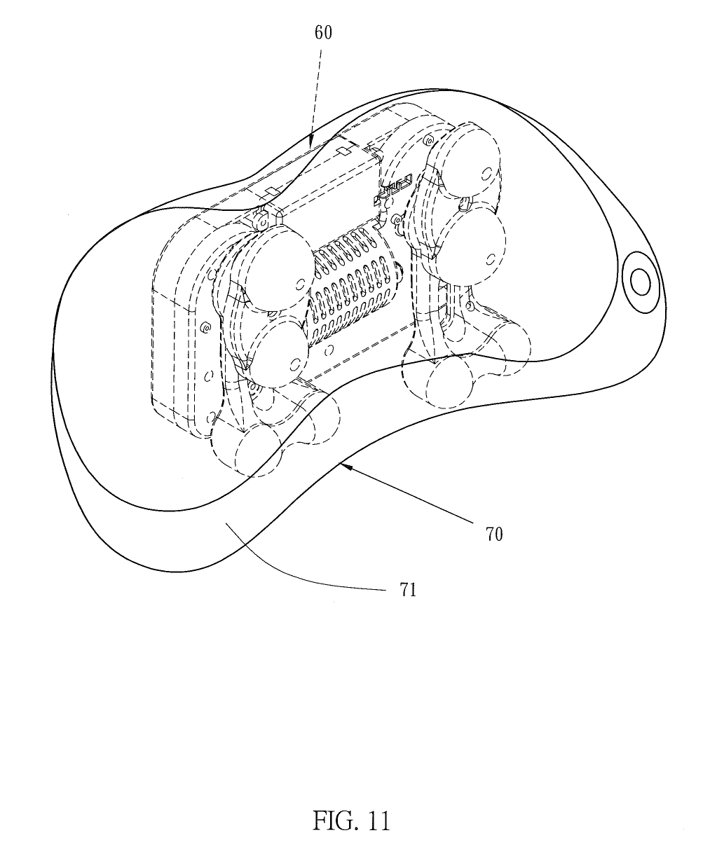

Referring to FIG. 11, regarding the rotating and extensible swinging massage head units, the massager 60 is disposed in a massage pillow 71, so as to form a massage pillow-style massager 70.

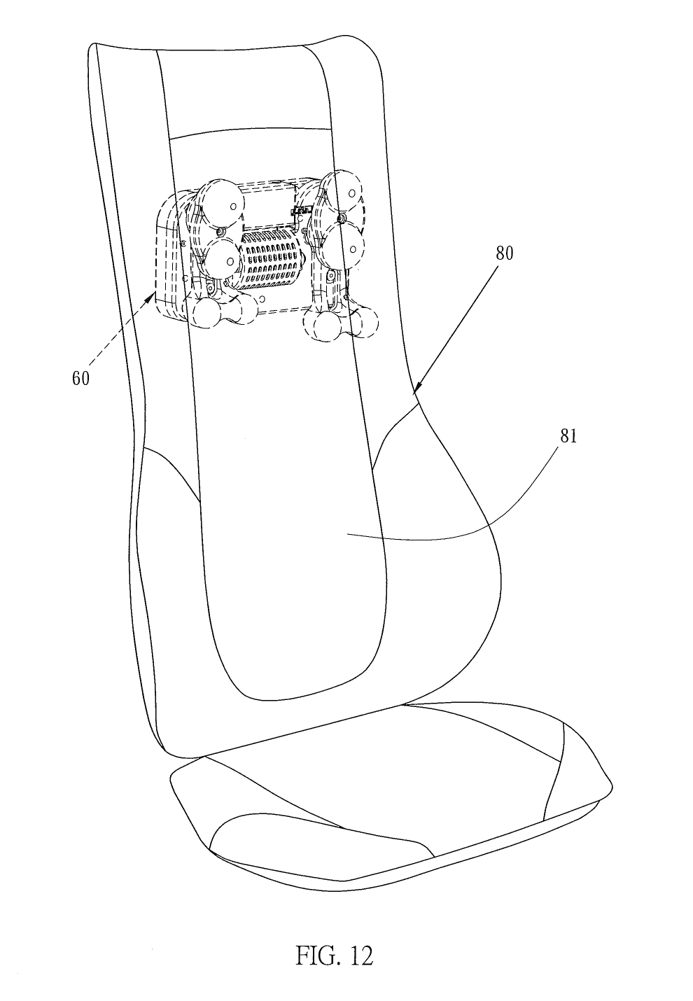

Referring to FIG. 12, regarding the rotating and extensible swinging massage head units, the massager 60 is disposed in a massage chair cushion 81, so as to form a massage chair cushion-style massager 80.

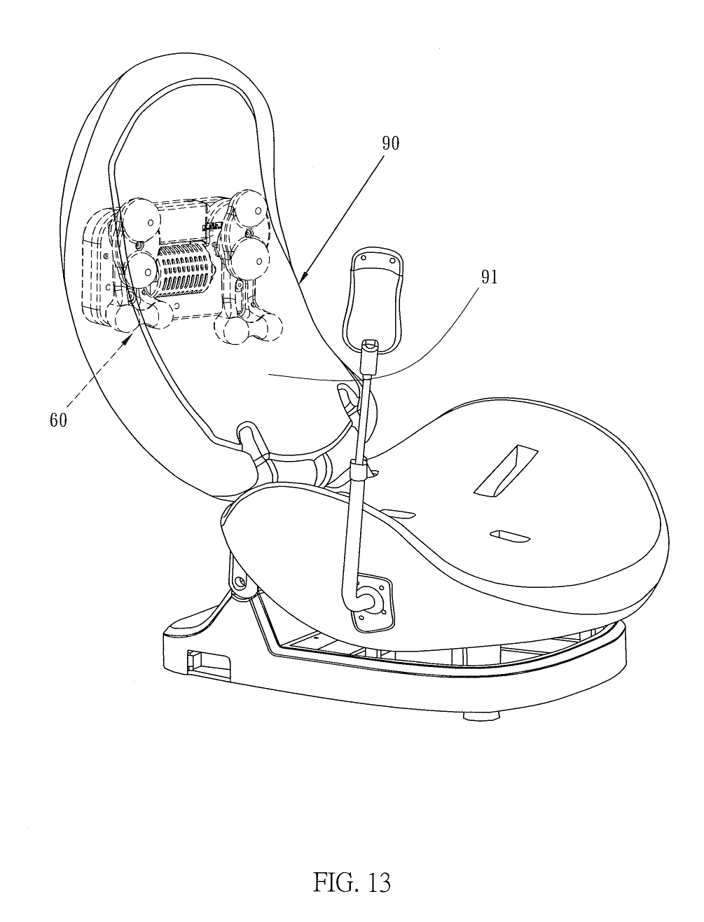

Referring to FIG. 13, regarding the rotating and extensible swinging massage head units, the massager 60 is disposed in a massage chair 91, so as to form a massage chair-style massager 90.

According to the present invention, a rotating and extensible swinging massage head unit is novel and thus meets the novelty requirements of a patent. It is extensively innovative and thus meets the non-obviousness requirement of a patent. The rotating and extensible swinging massage head unit includes a swinging arm. The swinging arm has a driven side capable of swinging eccentrically, a centrally-located oblong limiting slot, and an active side on which at least a massage bump is disposed. A turntable is disposed on the top side of the eccentric shaft and being concentric with the eccentric shaft, wherein at least a massage hemisphere is disposed on the top side of the turntable. Rotation of the eccentric shaft swings the swinging arm to perform a swinging kneading massage and rotates the turntable to perform a rotating massage simultaneously. Therefore, the rotating and extensible swinging massage head unit has high industrial applicability.

What is claimed is:

1. A rotating and extensible swinging massage head unit, comprising:
a ring having an eccentric shaft hole;
a swinging arm integrally extending laterally from the ring, the swinging arm having a centrally-located oblong limiting slot, a driven side connected to the ring, and an active side having thereon a massage bump,
an eccentric shaft inserted into the eccentric shaft hole of the ring and having therein a central axial pore; and
a turntable disposed integrally on a top side of the eccentric shaft and being concentric with the central axial pore, wherein a massage hemisphere is disposed protrudingly on a top side of the turntable,
wherein rotation of the eccentric shaft swings the swinging arm to perform a swinging kneading massage and rotates the turntable to perform a rotating massage simultaneously.

2. The rotating and extensible swinging massage head unit of claim 1, wherein the massage hemisphere comprises two massage hemispheres.

3. The rotating and extensible swinging massage head unit of claim 2, wherein the two massage hemispheres comprise a large massage hemisphere and a small massage hemisphere.

4. The rotating and extensible swinging massage head unit of claim 1, wherein the eccentric shaft is disposed on a bottom side of the turntable, wherein a central transmission shaft penetrates a top side of the casing and is inserted into the central axial pore integrally formed with the eccentric shaft to drive the eccentric shaft to rotate, wherein a limiting post is disposed protrudingly on the top side of the casing and engaged with the swinging arm and the oblong limiting slot, wherein a range of a swing of the swinging arm is effectively limited by the limiting post and the oblong limiting slot.

5. The rotating and extensible swinging massage head unit of claim 4, wherein the rotating and extensible swinging massage head unit comprises two rotating and extensible swinging massage head units arranged side by side and bilaterally symmetric, the casing is connected between the two rotating and extensible swinging massage head units and has therein a power mechanism, the power mechanism comprises a motor for driving a gear train, the gear train drives the central transmission shaft and thus drives the two rotating and extensible swinging massage head units to allow the rotating and extensible swinging massage head units to perform a stationary massage and the swinging arm to perform a swinging massage, thereby forming a massager, wherein the two rotating and extensible swinging massage head units of the massager perform a stationary massage and a swinging kneading massage on shoulders, neck, and back of a human body.

6. The rotating and extensible swinging massage head unit of claim 5, wherein the massager is disposed in a massage pillow, so as to form a massage pillow-style massager.

7. The rotating and extensible swinging massage head unit of claim 5, wherein the massager is disposed in a massage chair cushion, so as to form a massage chair cushion-style massager.

8. The rotating and extensible swinging massage head unit of claim 5, wherein the massager is disposed in a massage chair, so as to form a massage chair-style massager.
